(19) United States
(12) Patent Application Publication
(10) Pub. No.: US 2016/0221161 A1
(43) Pub. Date: Aug. 4, 2016

(54) ADJUSTABLE PIN SPANNER CROSS BEAM

(71) Applicants: Fernando Garcia Magallon, FPO, AP (US); Maria Geraldine Magallon, Ginowan (JP)

(72) Inventors: Fernando Garcia Magallon, FPO, AP (US); Maria Geraldine Magallon, Ginowan (JP)

(21) Appl. No.: 14/611,177

(22) Filed: Jan. 31, 2015

(51) Int. Cl. B25B 13/50; B25B 23/00

(52) U.S. Cl. CPC B25B 13/50; B25B 23/0035

(57) ABSTRACT

The purpose of this adjustable pin spanner cross beam tool design is to allow the Support Equipment technician in the field of Aviation Maintenance to conduct expedited repairs and eliminating damage to 12-ton and 25-ton Columbus-manufactured aircraft jack lock-collars. There has been an issue of severe damage and the inability to remove individual ram lock-collars in the fleet in reference to 12-ton and 25-ton aircraft jacks. This tool is designed for use and to fit all lock-collars of these two multi-stage aircraft jacks. The use of this tool also saves time wasted in attempted removals that have been documented to add over 60 man-hours for a single lock-collar. The removal of the aforementioned lock collars will be reduced to as little an estimated 1-5 minutes depending on jack condition with no damage occurring to the jack lock-collar/components when properly utilized.

### CROSS-REFERENCE TO RELATED APPLICATIONS

Not Applicable

### STATEMENT REGARDING FEDERALLY SPONSORED RESEARCH OR DEVELOPMENT (IF APPLICABLE)

Not Applicable

### REFERENCE TO SEQUENCE LISTING, A TABLE, OR A COMPUTER PROGRAM LISTING COMPACT DISC APP (IF APPLICABLE)

Not Applicable

### BACKGROUND OF THE INVENTION

This invention is a tool applicable for use in mechanical maintenance actions aimed towards repair, or simple periodic maintenance of aircraft Jacks. Two types of aircraft jacks in the field of Aviation Maintenance contain a type of lock collar, which is extremely difficult to remove without such a tool. Most aircraft jacks have more than one ram (also referred to as stages) to reach increased heights. The lock collars in these jacks come in different sizes, increasing in size in the lower stages of rams. This invention is designed to fit all sizes of lock collars (adjustable feature) and provide easy removal for internal cylinder/ram repair of multi-stage jacks.

The information known to me, by experience in the field of Aviation Maintenance, is that no technical publication contains any reference for a tool to remove these lock collars. The issue in the fleet is that there is a significant waste of man-hours in mission-critical maintenance well over 60 hours in the removal of one ring without the invention. The tool will provide easy removal in one to five minutes of time. There is no current tool that exists based on my research to find one initially to correct this deficiency in aviation maintenance. All general/common pin type spanner wrenches on the market that exist have larger pins than what is required on the jack's lock collars. The larger the lock collar, the larger the tool required, which ultimately has pins that are too large for use. Also, the designs of the existing oversized pin tools would not be very effective on ring removal even if the pins were the correct size.

### BRIEF SUMMARY OF THE INVENTION

This tool is applicable to a wide variety of maintenance tasks of multi-stage jacks in the removal of all sizes of lock collars. It may also applicable to many other types of equipment where pin type spanner wrenches may be suitable for use. This tool consists of a cross beam with four slides, where each slide has an adapter with an application-specific pin. All four adapters are identical for use on two-pin, or four-pin configuration/application.

### BRIEF DESCRIPTION OF THE SEVERAL VIEWS OF THE DRAWING

FIG. 1—Top View of the cross beam with measurements indicated. Top view also shows the slide lengths where adapters slide for adjustment to fit different sizes.

FIG. 2—Expanded top view of a cross beam arm, showing radius measurements to aid in manufacture, and inner radius of pin adapter slide.

FIG. 3—Depicts top view and side view of cross beam with a half-inch drive, to include measurements and an expanded view. FIG. 3A shows the top centered view of the half-inch drive and its dimensions. FIG. 3B shows an expanded view of the half-inch drive with measurements for ease of understanding. FIG. 3C shows the side view of the half-inch drive on the cross beam with measurements.

FIG. 4—Shows top view of an adapter with measurements, and tap size (Bolt thread size).

FIG. 5—Front View of an adapter with measurements and taper down to pin.

FIG. 6—Back vies of an adapter with measurements and taper.

FIG. 7—Side view of an adapter with measurements and Taper.

FIG. 8—Bottom view of an adapter with measurements and taper.

FIG. 9—Top view of assembled invention.

FIG. 10—Side view of assembled invention.

### DETAILED DESCRIPTION OF THE INVENTION

This invention is designed for use with single-stage, or multi-stage aircraft jacks. This invention is designed to be adjustable to accommodate all sizes of lock collars that exist with 12-Ton and 25-Ton Columbus-manufactured aircraft jacks. The cross beam has four slides each measuring 3 inches, to allow for a positioning of four pin adapters anywhere from a range of about 2.5 inches to a maximum of about 8 inches apart. The invention also has the capacity to have two adapters removed to allow a two-pin configuration if needed on a small lock collar.

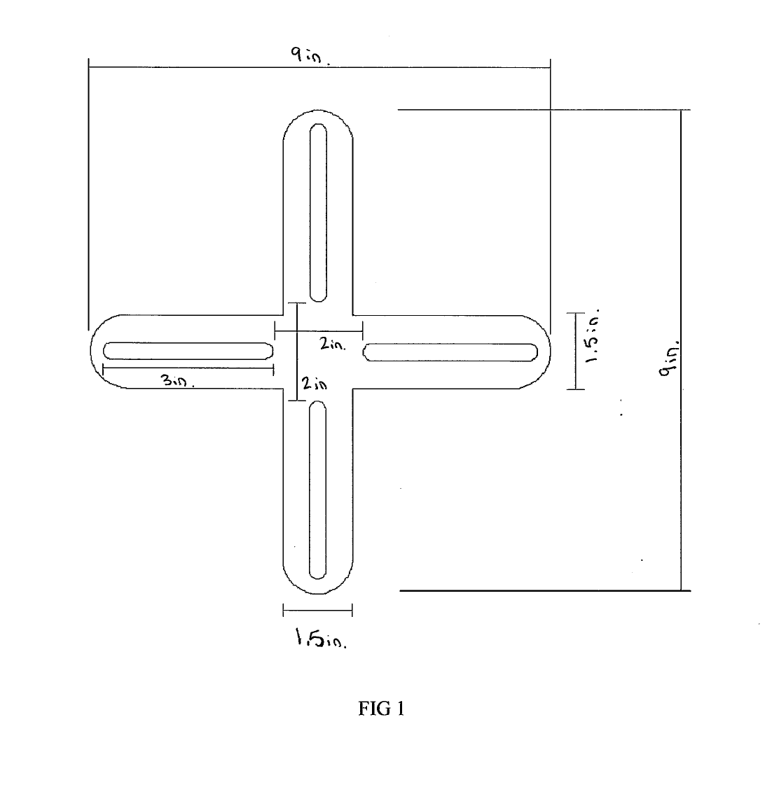

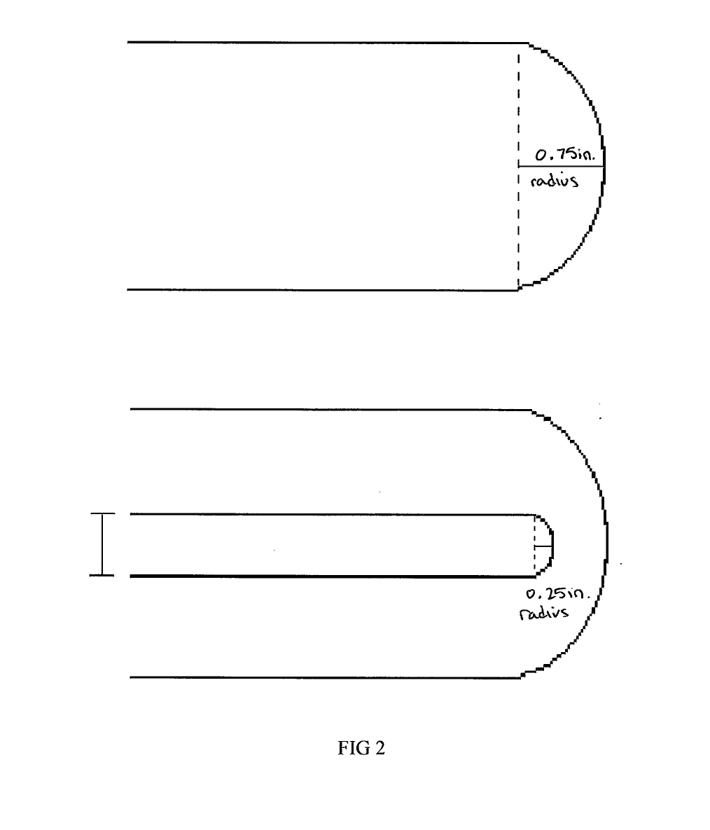

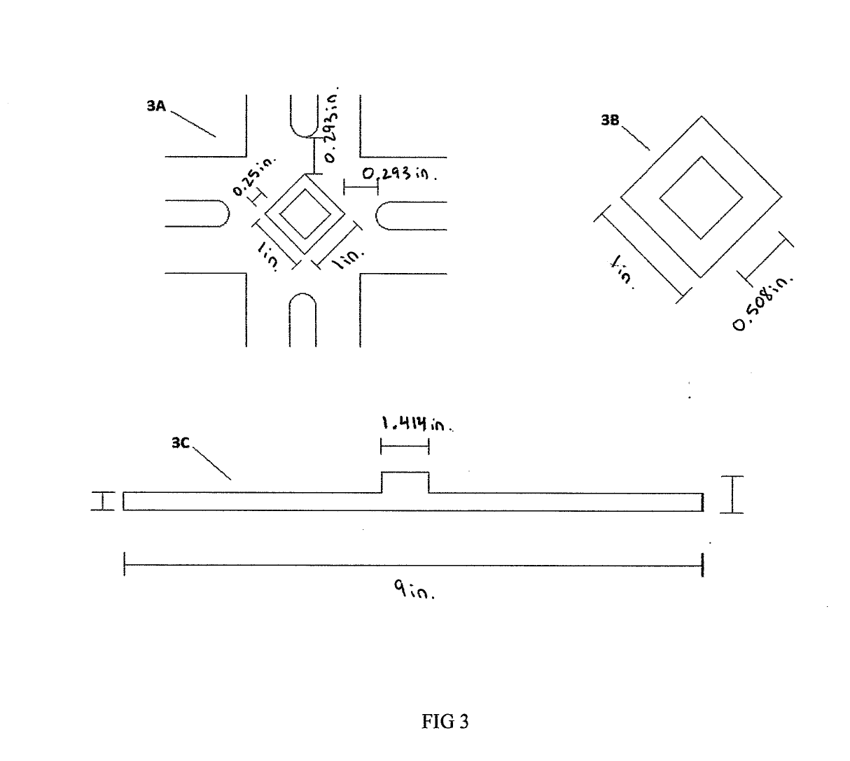

The invention will be referred to as a tool in the following text for ease of explanation. The design of the cross beam (FIG. 1, FIG. 2) is a quarter inch thick, cross-style beam, 9 inches long in both directions, 1.5 inches wide on all arms, with four 3-inch long slides for the placement of four pin adapters. Composition of the entire tool is chrome-vanadium steel. The cross beam has a square-shaped half-inch drive (FIG. 3) for use with breaker bars and ratchets, for heavier duty applications that require more leverage. The offset drive allows for long breaker bar use without the cross-beam arms interfering with the user's hand.

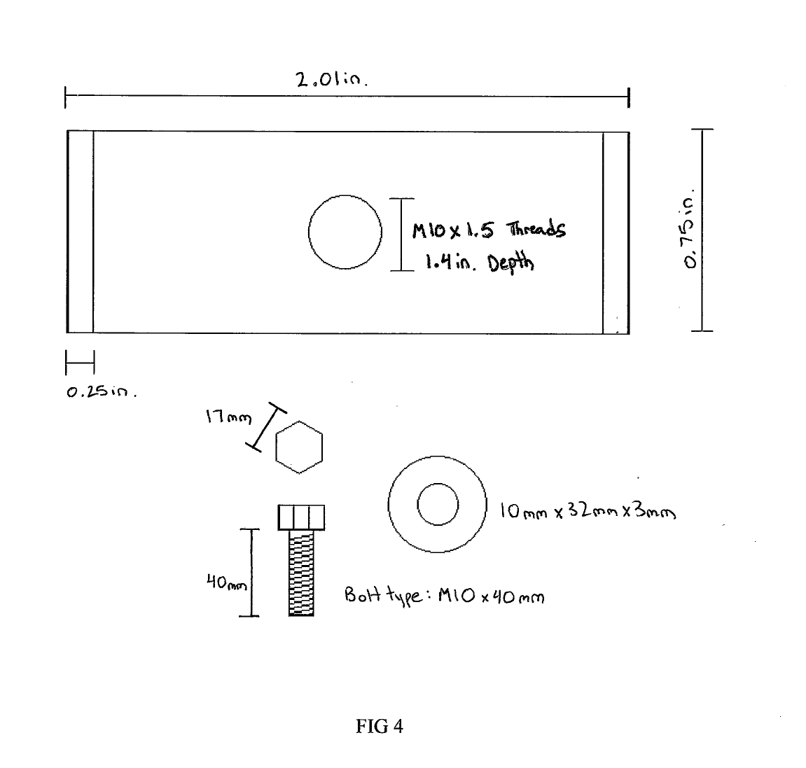

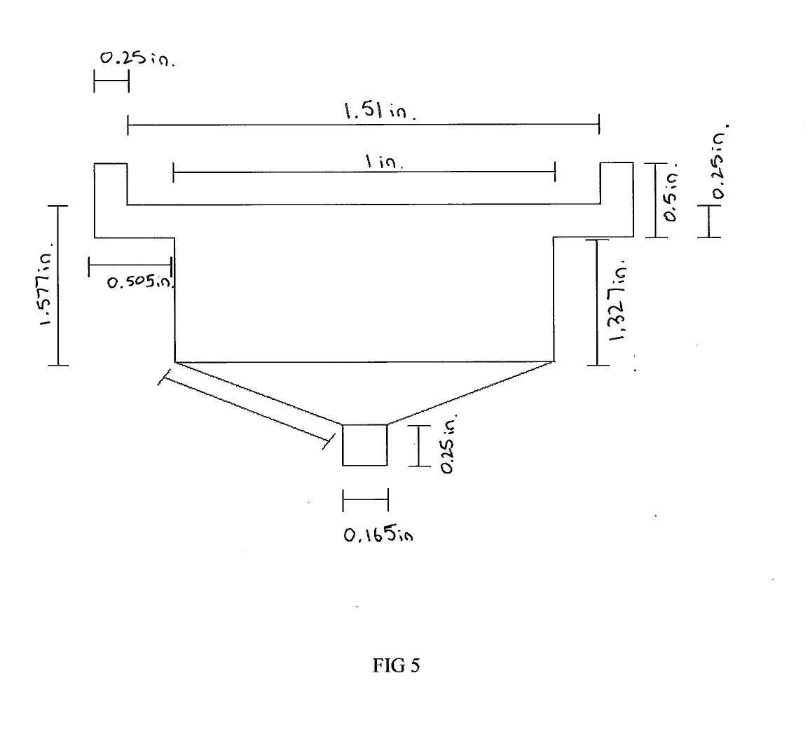

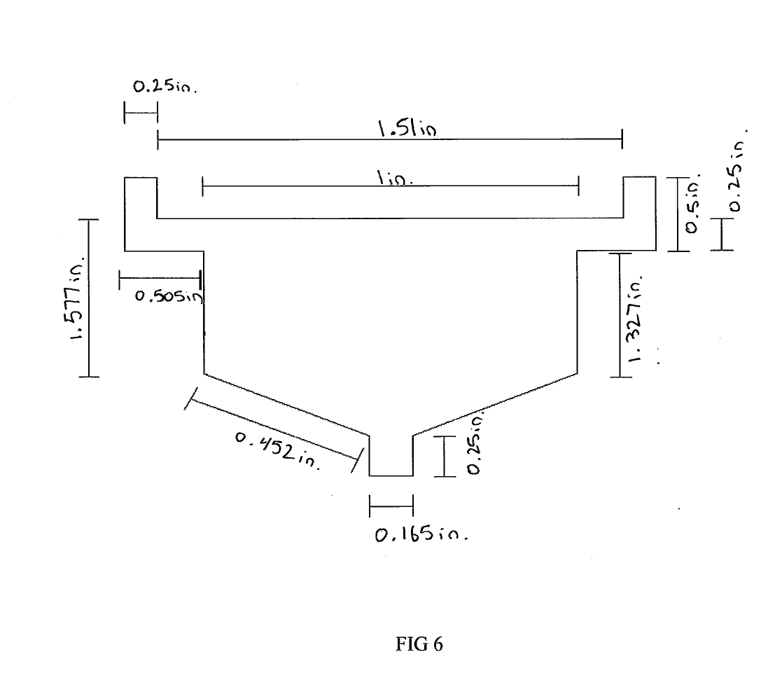

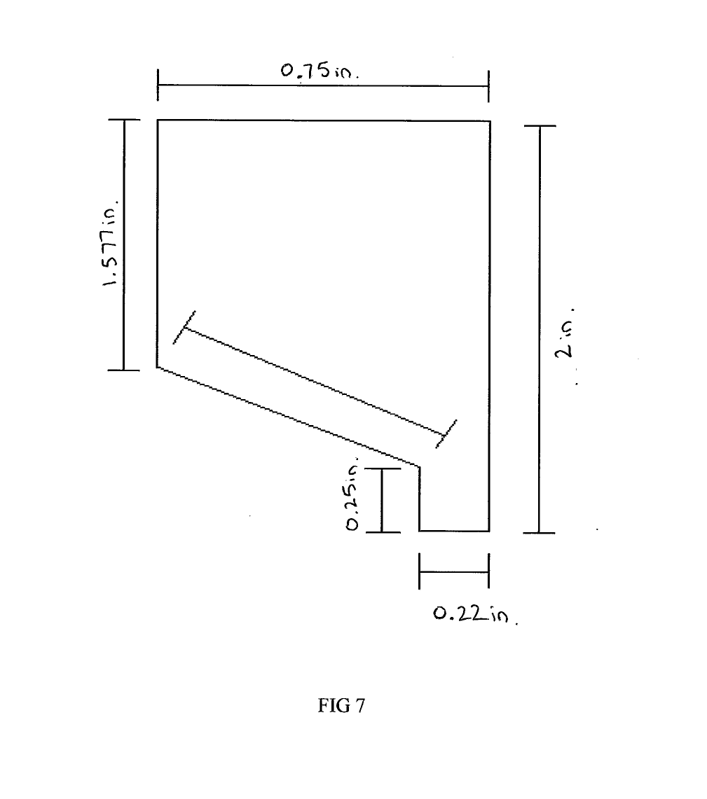

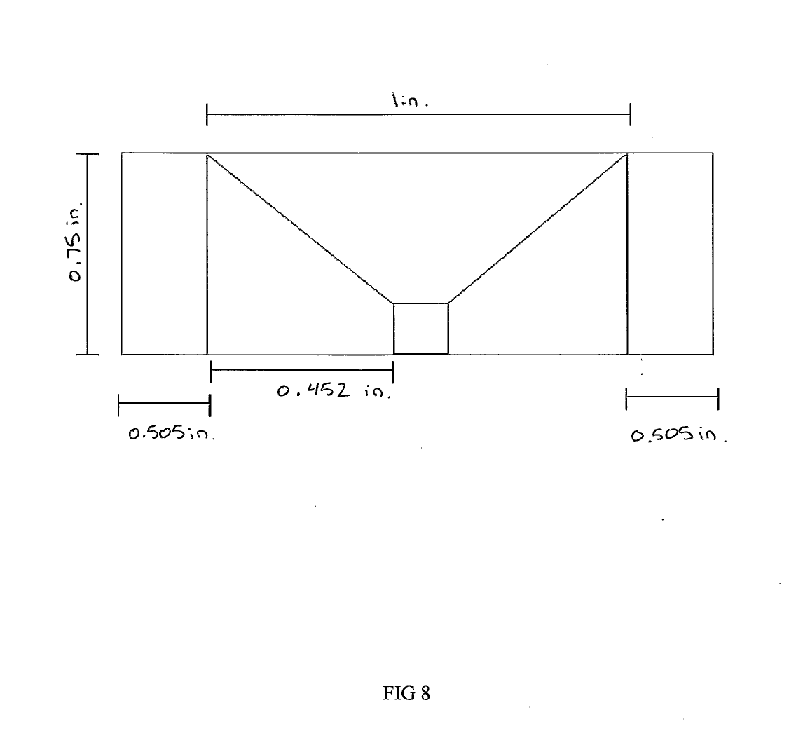

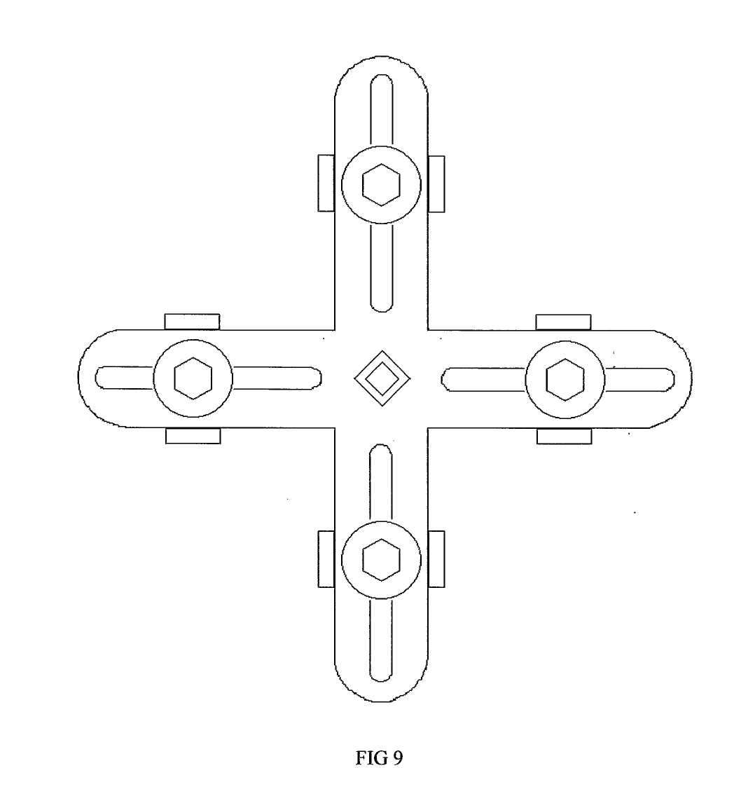

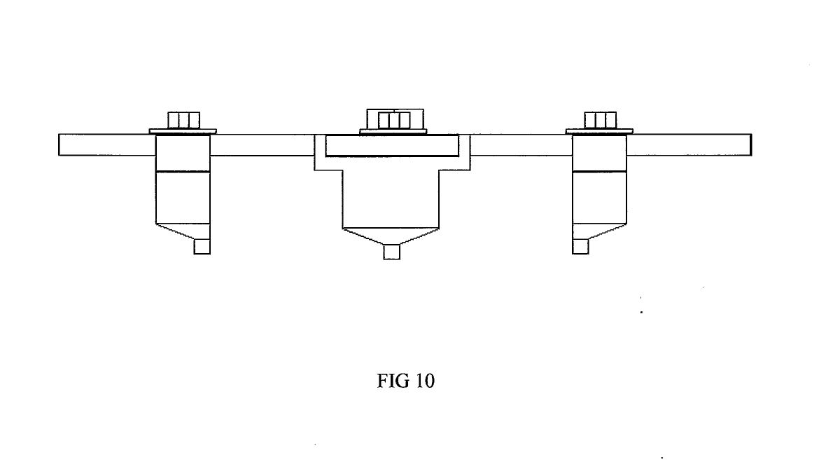

The design of the pin adapters (FIG. 4, FIG. 5, FIG. 6, FIG. 7, FIG. 8) is so that four adapters have a taper on each closest to the pins, to allow for the user to see its positioning. The backside of each pin adapter is flat (FIG. 6), to act as a sliding guide against the ram surface. This feature allows for stability against the jack in order to keep the tool secure as pressure is applied to rotate off the lock collar with ease. Each slide has guides (FIG. 4, FIG. 5, FIG. 6) that are in place to guide the pin adapter along the slides, and to keep them from rotating in an unwanted direction. These guides also provide increased adapter stability, and resistance to damage in increased loads by distributing the force of the loads between the adapter guides and cross beam side rails. The adapters are each secured by a washer and a bolt (FIG. 4). A top view of the assembled tool with all components attached is shown in (FIG. 9). A side view of the assembled tool with all components attached is shown in (FIG. 10).

The process of making this invention, is through casting the cross beam and four adapters out of chrome-vanadium steel, then machining to specifications shown in drawings (FIG. 1-FIG. 8). The bolt holes meant for securing the pin adapters will be drilled, and tapped with the proper threads shown in (FIG. 4).

This tool was designed due to the inability to find any usable tool to remove lock collars on these aircraft jacks. Currently, lock collars are removed with a punch and hammer, which ultimately destroys the lock collar on removal and significantly damages the new replacement being put on. All current pin-type spanner wrenches on the market are not suitable for use in their design, nor sizes that are available. The larger the sizes, the larger the pins, already rendering the tool useless for aircraft jack application. The tool design also arose from noticing a significant waste of man-hours in maintenance actions, usually 60 or more hours in one instance of attempt to remove one lock ring with a punch and hammer. The tool will allow for removal in 1 to 5 minutes approximately.

1. A hand tool consisting of:
1—A chrome-vanadium steel cross beam with adjustable adapter positioning slides
2—Four chrome-vanadium pin adapters that attach to the cross beam
3—Tool used for removal of all sizes of lock collars from rams on aircraft jacks.
